(19) United States
(12) Patent Application Publication
(10) Pub. No.: US 2010/0199454 A1
(43) Pub. Date: Aug. 12, 2010

(54) Latch Assembly for a Vacuum System

(75) Inventors: Anthony Pruitt, Normal, IL (US); Matthew J. Arteaga, St. Joseph, IL (US); Bart K. Bieker, Bloomington, IL (US); Davin Vandenbroeke, Normal, IL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Electrolux Home Care Products,Inc.

(21) Appl. No.: 12/700,482

(22) Filed: Feb. 4, 2010

Related U.S. Application Data
(60) Provisional application No. 61/150,569, filed on Feb. 6, 2009.

(51) Int. Cl. A47L 5/38; E05C 21/00; E05C 1/10

(52) U.S. Cl. 15/301; 292/2; 292/145; 292/152

(57) ABSTRACT

A latch assembly for a central vacuum cleaner. The latch includes a buckle attached to a vacuum housing. The latch also includes a lower latch assembly having a bracket connected to and extending laterally from a dirt container, a locking member mounted on the bracket and being movable between a first position in which the a lock engages the buckle to prevent removal of the dirt container, and a second position in which the lock does not engage the buckle. At least a portion of the bracket is configured as a rigid handle adapted to be held by a user to remove and replace the dirt container. A button may be provided to operate the locking member, and a spring may be provided to bias the button to one position. A central vacuum cleaner incorporating a latch is also provided.

### FIELD OF THE INVENTION

The present invention relates to a latch assembly for coupling a dirt receptacle to a vacuum cleaner housing. The invention may be used in any suitable vacuum cleaner systems, such as upright vacuum cleaners, commercial vacuums, wet extractors, stick vacuums, canister vacuums, central vacuums, and the like.

### BACKGROUND OF THE INVENTION

Electric vacuum cleaning systems have become ubiquitous as the preferred method of cleaning carpeted and hard floors. These devices are manufactured in a variety of configurations including central, canister, upright, power wands, power heads, handhelds, etc. These different vacuum types differ in many design features such nozzle size and configuration, power agitation, cyclonic airflow and advanced dust filtering, however, they all typically share various components. Portable vacuum cleaner systems typically include a handle portion connected to a cleaning nozzle or other attachment, a dirt container and a vacuum motor—that is, a motor and fan assembly that generates a working airflow from the nozzle to the dirt container. Depending on the configuration all of these items may be integrated into an upright or wand unit, or the motor and container may be a separate canister unit tethered to the cleaning attachment via a flexible vacuum hose.

Due in part to the inconvenience of manipulating an entire vacuum cleaning system, and also the power, weight and size limitations of the typical portable vacuum systems, central vacuum systems are often used. Central vacuum systems use a central power unit with a relatively high-power vacuum motor and large dirt container. Such central vacuums are typically located outside of the main living area of a home, such as, for example, in a garage, basement, attic, etc. A network of conduits hidden below floorboards, above ceilings and between walls connects wall-based vacuum outlets to the central power unit. The power unit is usually connected to a dedicated 15 amp or larger power circuit and may run on 240 and 120 volt alternating current power (AC), but power requirements may vary depending on the characteristics of the local power system or system requirements. By isolating the powerful vacuum motor outside of the primary living area, the homeowner is able to enjoy strong suction power not typically available in conventional integrated vacuum cleaning devices without having to hear the noise that such a high power vacuum motor generates and without having to physically manipulate such a unit. Typically, central vacuum systems are equipped with one or more hose/cleaning attachment modules that connect to vacuum outlets located throughout the house. In addition to providing an airflow path from the cleaning attachment to the dirt canister and vacuum motor, these wall connectors may provide a power connection to operate active components of the cleaning attachments and permit the user to turn the vacuum unit on and off. U.S. Pat. No. 5,400,463 illustrates an example of a central vacuum system. This patent is incorporated herein by reference in its entirety.

Though central vacuum systems differ from portable vacuum systems in that they are typically more robust and are built into the house, their basic design has many similarities with conventional portable vacuums. One common feature is a dirt container or bucket to hold captured dirt and debris. In a central vacuum, the dirt container typically is located at a central power unit that houses the vacuum motor. The dirt container may be removable attached to and forms the lower section of the central power unit. Similar dirt receptacles are sometimes employed in portable vacuum cleaner systems, but the dirt container on a central vacuum system generally is larger than the container on a portable system, such as an upright of canister vacuum. The dirt container may contain a bag or other filter (such as a pleated filter), or it may simply receive dirt separated by a filter or an inertial and/or cyclonic separation system. The manner in which the dirt is separated from the airflow is not particularly relevant to the invention described herein. Vacuum cleaner dirt containers usually are detachable from the rest of the system to allow the user to empty accumulated dust and dirt, but in some cases they may be permanently installed and emptied using a trapdoor or other opening. Where the container is removable, it may have some form a mating assembly to connect the container to the vacuum cleaner and lock it in place. In central vacuum cleaners, an over-center strap latch is used to attach the dirt container to the central unit, but other latches may be used instead.

These attachment assemblies may suffer from various drawbacks, such as being difficult to manipulate, align, and actuate. This is particularly true in the case of central vacuum cleaners, in which the user often must support the weight of the container while aligning it and latching it in place. These design drawbacks may lead to damage or failure of the attachment assembly. Other problems and drawbacks may exist with known systems.

### SUMMARY OF THE INVENTION

In one aspect, there is provided a latch assembly for a central vacuum cleaner. The latch assembly may have a buckle attached to a vacuum housing and a lower latch assembly. The lower latch assembly may include a bracket connected to and extending laterally from a dirt container, and a locking member mounted on the bracket and having a lock on it. The locking member may be movable between a first lock position in which the lock engages the buckle to prevent removal of the dirt container from the housing, and a second lock position in which the lock does not engage the buckle to permit removal of the dirt container from the housing. At least a portion of the bracket may be configured as a rigid handle adapted to be held by a user to remove and replace the dirt container.

In another aspect, there is provided a vacuum cleaner latch assembly having a buckle attached to a vacuum housing, and a lower latch assembly. The lower latch assembly may have a handle connected a dirt container, a button mounted on the handle and adapted to move relative to the handle between a first button position and a second button position, a spring adapted to bias the button from the second button position to the first button position, and a locking member adapted to move between a first lock position in which the locking member is positioned to engage the buckle and a second lock position in which the locking member is positioned not to engage the buckle. The lock button may have one or more first surfaces adapted to move the locking member from the first lock position to the second lock position when the button is moved from the first button position to the second button position, and one or more second surfaces adapted to move the locking member from the second lock position to the first lock position when the button is moved form the second button position to the first button position.

In another aspect there is provided a central vacuum cleaner having an upper housing having a vacuum fan contained in it, a dirt container adapted to selectively connect to a bottom of the upper housing to receive dirt separated by the central vacuum cleaner from an air flow generated by the vacuum fan, at least one buckle extending downward from the upper housing, and at least one latch mounted on the dirt container to selectively connect the dirt container to the upper housing. The latch may have a handle rigidly attached to the dirt container and configured to be held by a hand of a user, a movable button located on the dirt container at a location where the button can be operated by the hand of the user while the hand is holding the handle, and a lock movable by the button between a first position in which the lock is positioned to engage the buckle, and second position in which the lock is positioned not to engage the buckle.

It will be understood that the foregoing summary of the invention is provided for illustrative purposes only, and is not intended to modify or narrow the scope of the claims in any way.

### BRIEF DESCRIPTION OF THE DRAWINGS

The present inventions are described in detail with reference to the exemplary embodiments shown in the following figures, in which like parts are designated by like reference numerals.

FIG. 1 is a front perspective view of an exemplary embodiment of a central vacuum.

FIG. 2 illustrates the embodiment of FIG. 1 with the dirt container detached.

FIG. 3 is an exploded view of the embodiment of FIG. 1.

FIG. 4 is an exploded view of one exemplary latch shown in FIG. 3.

FIGS. 5A and 5B are cutaway front views of an exemplary latch of FIG. 3, shown in the locked and unlocked positions, respectively.

### DETAILED DESCRIPTION OF EMBODIMENTS OF THE INVENTIONS

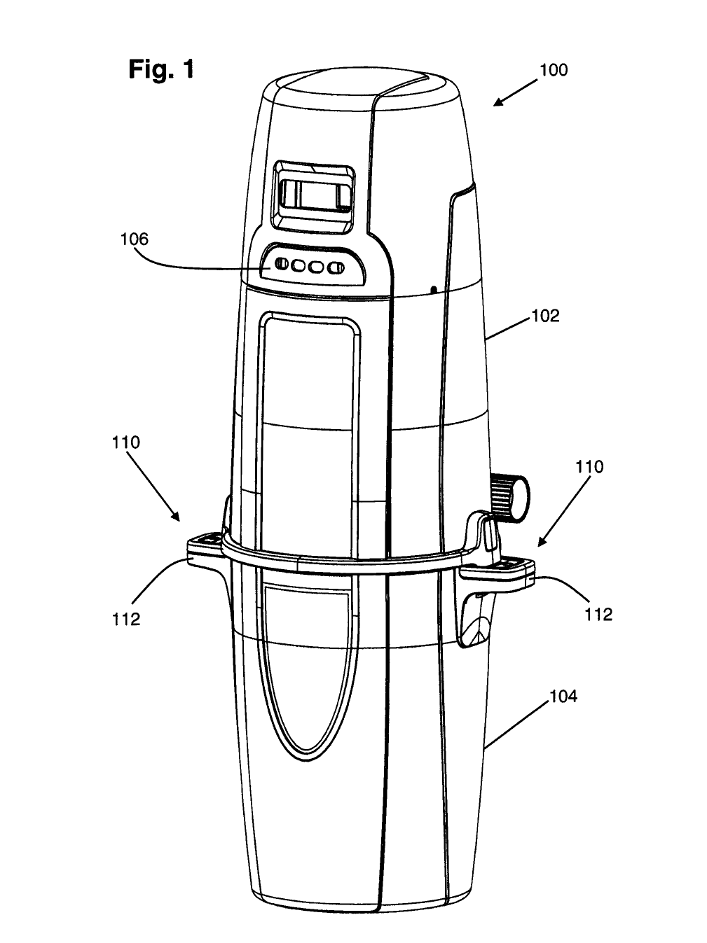

The present disclosure provides a latch feature for vacuum cleaners. An exemplary embodiment of such a feature is described with reference to one exemplary use in a central vacuum cleaner, such as the central vacuum shown in FIG. 1, to secure a dirt container to a power unit. It will be appreciated, however, that latches having different specific structures and other uses for the latch features described herein can be used in various other contexts. For example, embodiments can be used with upright vacuums, canister vacuums, stick vacuums, portable and handheld vacuums, shop vacuums, wet extractors, and so on. Furthermore, the various features described herein may be used separately from one another or in any suitable combination. The present disclosure illustrating an exemplary embodiment is not intended to limit the invention in any way.

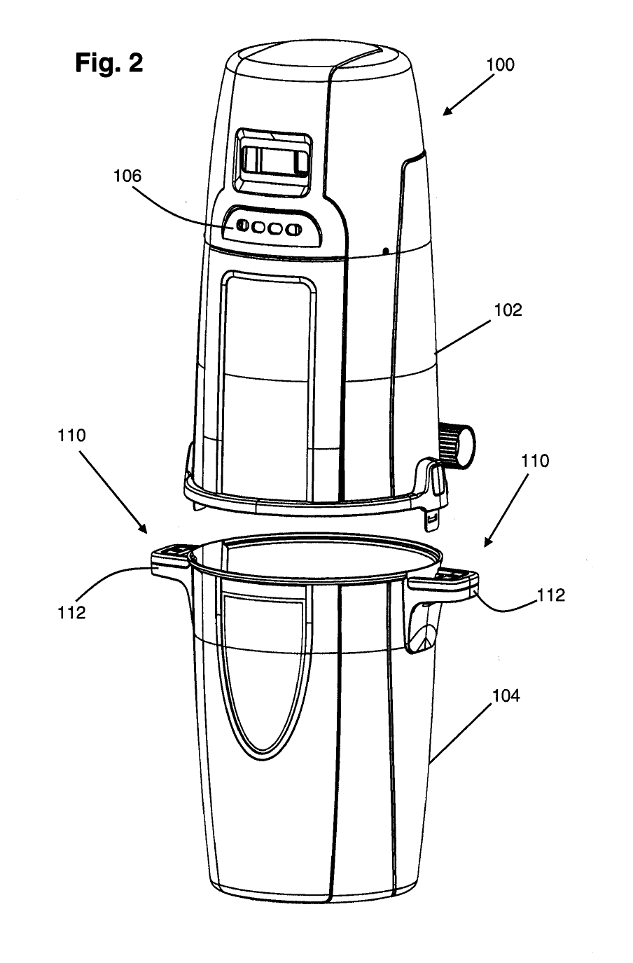

As shown in FIGS. 1 and 2, a central vacuum unit 100 may have an upper housing 102 containing various operating parts, such as control electronics 106 and a fan/motor unit 108 having a suction fan and electric drive motor, as known in the art. A dirt container in the form of a dirt container 104 is attached to the bottom of the upper housing 102, and is configured to contain dirt and dust that may be suctioned up through an attached vacuum hose (not shown) during operation of the central vacuum. The system may include a bag or other filter to separate the dirt from the airstream. Typically, a bag is provided towards the bottom of the upper housing 102, and hangs towards the container 104. Alternatively, a bagless system may be used wherein the dirt and dust is separated by inertia and/or centrifugal force (e.g., using a cyclone), as known in the art. The separated dirt falls into the container 104, where it remains until the system is emptied by the user. A supplemental filter assembly may also be used to clean the air leaving the fan/motor 108 before the air is vented to the atmosphere, as known in the art.

The dirt container 104 may be attached to the upper housing by one or more latch assemblies 110. FIG. 1 shows these parts attached, and FIG. 2 shows them detached. In an exemplary embodiment, two latch assemblies 110 may be used. The latch assemblies 110 are shown located on the sides of the upper housing and dirt container, but alternative positions, such as on the front and back of the upper housing and dirt container, may be used. The shown arrangement is expected to be easy for an operator to reach using two hands—one on either side of the device. If desired, the portions of the latches 110 on the unit 100 may be mounted on a rotating collar (not shown) that allows them to be reoriented to provide access if the unit 100 is mounted in a corner or otherwise positioned to obstruct access to the latches 110 where they are presently located.

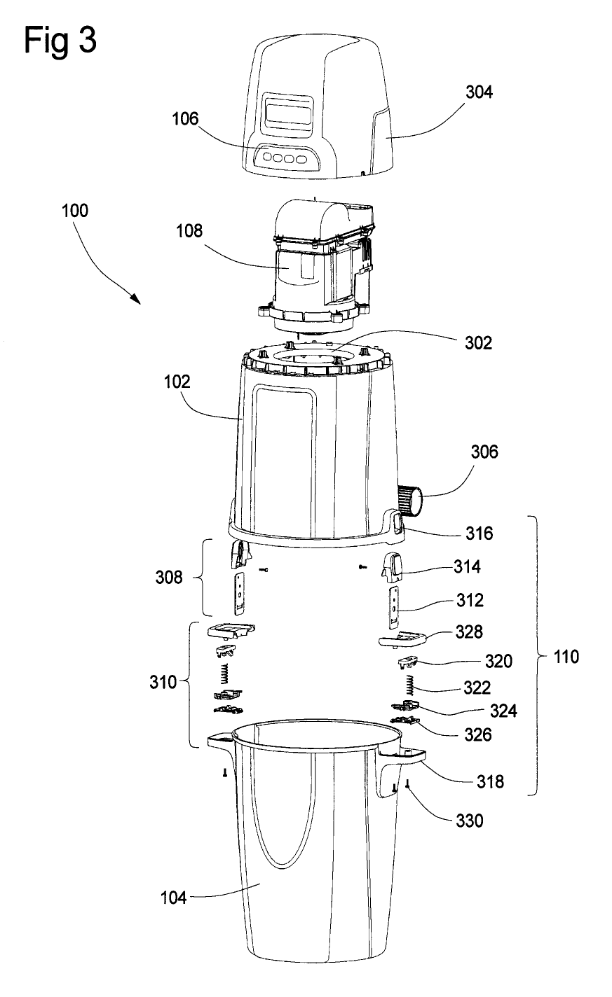

FIG. 3 is an exploded view of the exemplary central vacuum unit 100. As shown, the upper housing 102 may have an opening 302 at the top, upon which the fan/motor 108 is mounted. The control electronics 106 and associated user interface and display are mounted on a cover 304 that fits over the fan/motor 108. An air inlet 306 enters the upper housing 102, and is adapted to connect to air pipes or hoses extending throughout the building structure. Plural inlets may be used to accommodate mounting requirements, as known in the art.

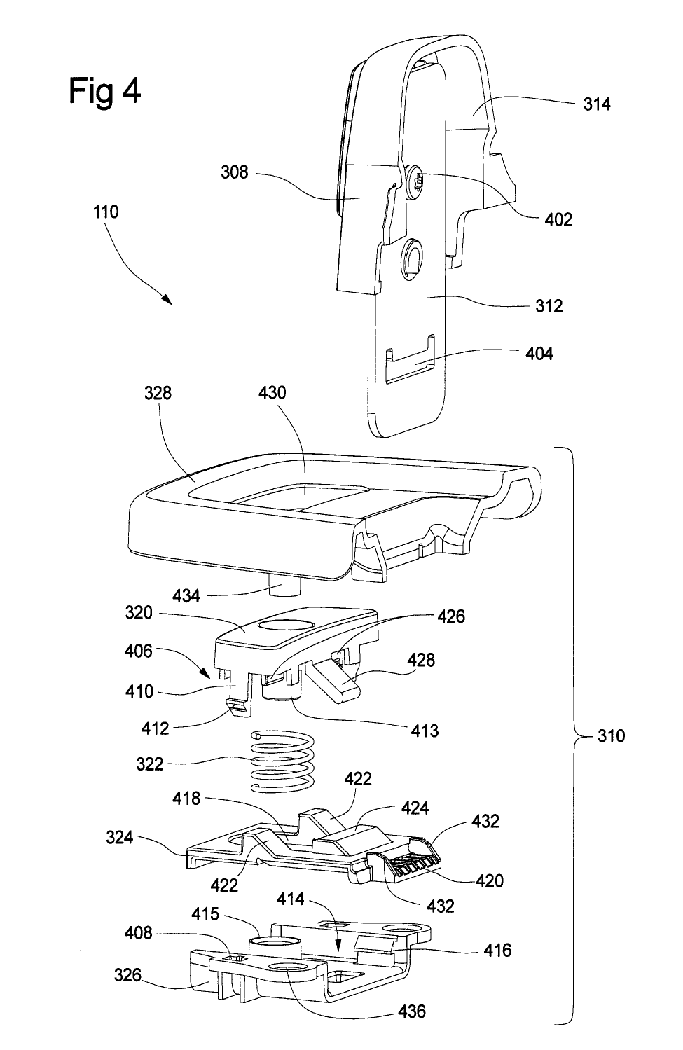

Referring to FIGS. 3 and 4, the exemplary latches 110 are described in detail. Each latch 110 includes an upper portion 308 that is affixed to the upper housing 102, and a lower portion 310 that is affixed to the dirt container 104. The upper portion 308 selectively connects with the lower portion 310 to provide a secure, air tight fit between the upper housing 102 and dirt container 104. The upper housing 102 and container 104 may include flanges, gaskets, or other structures around their outer periphery to provide an air-tight fit, help align the parts, and prevent excessive wear between the parts, as known in the art.

The upper portion 308 of the exemplary latch assembly 110 has a buckle 312 that is affixed to the upper housing 102 by a mounting bracket 314. As shown in FIG. 4, the buckle 312 is attached to the mounting bracket 314 by one or more screws 402, and the assembled parts are mounted in a cutout 316 or pocket in the upper housing 102 by snap-fitment and/or other connections, such as screws, bolts, or bayonet fittings. The vertical position of the buckle 312 relative to the mounting bracket 314 may be adjustable to allow a manufacturer, user or service technician to change the height of the buckle 312 to properly engage the lock. This may be done, for example, by passing the screw 402 through a vertically-extending slot through the buckle 312, and moving the buckle 312 along the slot to the proper location to mate with the lock. The buckle 312 may be held firmly so that it can not move when it is attached to the upper housing 102, but it also may be desirable to permit some movement to correct for misalignment and manufacturing tolerance variations. The connection between the buckle 312 and the housing 102 should be strong enough to support a filled dirt container 104, and any suitable arrangement of interlocking parts, fasteners, and the like may be used to provide the necessary strength at this connection.

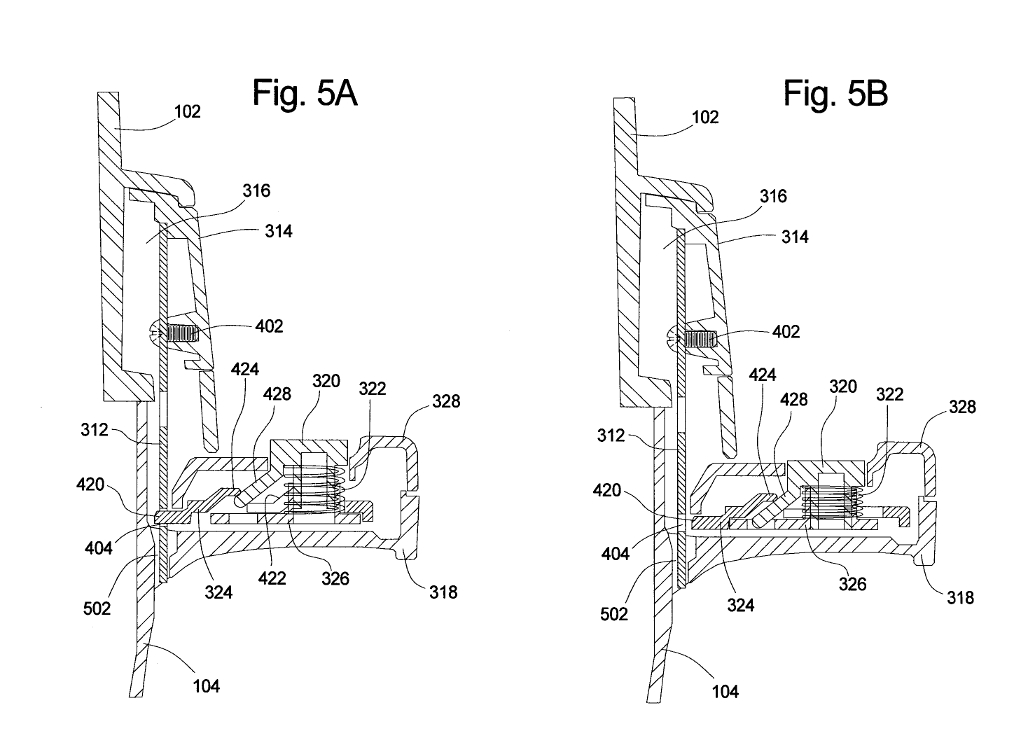

As best seen in FIG. 4, the lower end of the exemplary buckle 312 has a slot 404 for mating with the lower latch portion 310. In addition, the lower end of the buckle 312 may be designed to fit into a slot 502 (FIG. 5A) in the lower latch portion 310.

As noted above, the lower latch portion 310 is connected to the dirt container 104. In the shown embodiment, part of the lower latch portion 310 is formed as a mounting bracket 318 on the dirt container 104. This is facilitated in the shown embodiment by making the dirt container 104 out of a plastic material, but an integral bracket may also be made on a container formed from steel or other metals. The mounting bracket 318 portion of the lower latch portion 310 also may be formed separately and attached to the container 104.

The lower latch portion 310 may comprise any suitable securing and release assembly that selectively connects to the buckle 312 to hold the dirt container 104 in place. In the shown exemplary embodiment, the lower latch portion 310 includes a button 320, a spring 322, a locking member 324, and a lower retainer 326. The assembled button 320, spring 322, locking member 324 and lower retainer 326 may be secured to the mounting bracket 318 by one or more screws 330, as shown in FIG. 3. For example, the screws 330 may fit upwards through the lower bracket and mate with holes in an upper cover 328 to capture the parts in place, but still allow the parts to move as necessary to operate the latch 110. Other fastening devices or arrangements may be employed to secure the latch assembly parts, as will be appreciated by persons of ordinary skill in the art in view of the present disclosure. The upper cover 328 helps hold the above parts in place or may simply cover them to prevent contact with a user. As shown in FIGS. 1 and 2, the upper cover 328 and mounting bracket 318 may cooperate to form handles 112 that an operator can use to manipulate the dirt container 104. As shown in FIGS. 5A and 5B, a slot 502 or groove may be provided to allow ingress of the buckle 312 into the lower latch portion 310.

In the exemplary embodiment, the top of the button 320 extends through a hole 430 in the upper cover 328, where it may be accessed by a user. The button 320 has fittings 406 that fit into corresponding holes 408 on the lower retainer 326. Each fitting 406 includes a post 410 having a protrusion 412 extending from one side of the post 410. The protrusion 410 is shaped and sized to snap fit into the hole 408 so that it can not be removed from the hole 408 during normal use. The post 410 is dimensioned to slide within the hole 408 and permit a predetermined amount of free vertical movement between the button 320 and the lower retainer 326 without permitting significant lateral movement between the parts. Two posts 410 are provided in the shown embodiment, but more posts may be used, or a single, centrally-located post may be used to connect the button 320 to the lower retainer 326 and permit a range of vertical movement.

The spring 322 is contained between the button 320 and the lower retainer 326, and may be in a slightly compressed state when these parts are assembled. The spring 322 thus biases the button away from the lower retainer 326 to return the button 320 to an upper position when no pressure is applied to the button 320. The exemplary spring 322 comprises a steel coil spring that fits around a spring retainer post 413 extending from the bottom of the button 320. The post 413 holds the spring 322 in place, and fits in a corresponding sleeve 415 formed in the lower retainer 326. The post/sleeve engagement may help align the button 320 and the lower retainer 326. In other embodiments, other spring materials and configurations may be used. For example, the spring 322 may comprise a flexible protrusion on the button 320 that extends towards the lower retainer 326, and is resiliently flexed when the button 320 is pushed towards the lower retainer 326. Other variations, such as providing multiple springs, will be readily apparent in view of this disclosure. Other changes, such as omitting the post and sleeve, also may be made.

The locking member 324 is captured between the button 320 and the lower retainer 326 in the shown exemplary embodiment. The locking member 324 sits in a channel 414 formed in the lower retainer 326. The channel 414 is shaped to permit the locking member 324 to slide back and forth along the channel 414, to thereby provide lateral movement relative to the button 320 and lower retainer 326. The channel 414 may include one or more retainers 416 to hold the locking member 324 in the channel 414. In the shown embodiment, the retainers 416 are illustrated as ledges that are positioned over the locking member 324, but other structures may be used, such as a head of a screw that passes through a slot in the locking member and is embedded in a hole in the lower retainer 326 with the head slightly above the upper surface of the locking member 324. The locking member 324 may include a central slot 418 through which the spring 322 and the spring retainer post 413 pass.

The exemplary locking member 324 includes a lock 420 that is shaped to fit into the slot 404 on the buckle 312. In the present embodiment, the lock 420 and slot 404 are both U-shaped, which provides engagement in the vertical and lateral directions. The locking member 324 also may include one or more structures that are used to move the locking member 324 laterally along the channel 414. For example, the exemplary locking member 324 includes one or more ramps 422 that extend upwards and away from the lock 420, and one or more protrusions 424 that face away from the lock 420. The ramps 422 are positioned under corresponding posts 426 that extend from the bottom of the button 320, and the protrusion 424 is adjacent a ramp 428 that extends from the bottom of the button 320. The posts 426 and ramps 422 are configured such that the posts 426 drive the locking member 324 along the channel 414 in a direction away from the end having the lock 420 when the button 320 is pressed downward. Conversely, the protrusion 424 and the ramp 428 on the button are positioned such that the ramp 428 drives the locking member 324 towards the end having the lock 420 when the button 320 moves upwards. This movement is illustrated in FIGS. 5A and 5B, which show the latch 110 in the engaged and disengaged positions, respectively.

It will be understood that many variations may be made to the foregoing arrangement of protrusions and ramps. For example, the protrusions may, themselves, be formed as ramps, or the locations of the protrusions and ramps may be reversed. Also, the features provided to cause the button 320 to push the locking member 324 towards the lock end may be removed and replaced by a spring that biases the locking member 324 into the locked position. In such an embodiment, it may be desirable to remove the spring 322 that returns the button 320 to the upper position, as that spring may become mostly redundant (a small spring 322 may still be desirable, however, to prevent the button 320 from dropping down when the locking member 324 is moved backwards by contact with the buckle 312 during reassembly, as described elsewhere herein).

As shown in FIG. 5A, the buckle 312 may extend downwards into a slot 502 formed in the lower latch portion 310. The lock 420, which may have a flat lower surface and a pair of wedge-shaped vertical extensions, mates with the slot 404 formed in the buckle 312, connecting the upper and lower portions of the latch assembly and thereby attaching the dirt container 104 to the housing 102. Providing a wedge shape at the end of the lock 420 may help the buckle 312 to slide into place in the slot 404 during latch engagement. Specifically, the buckle 312 will contact the angled surface of the wedge shape to generate a vector force to push the lock 420 and locking member 324 out of the path of the buckle 312. The spring 322 presses upwards on the button 320 to hold the locking member 324 in the locked position, but this spring bias may be overcome by the aforementioned vector force.

Engagement between the lock 420 and slot 404 may provide all of the retaining force necessary to hold the dirt container 104 in place against the housing 102. Stated differently, the dirt container 104 is suspended from the housing 102 against the force of gravity by the latches 110. In the exemplary embodiment, the weight of the dirt container 104 is transmitted to each buckle 312 by the bottom of each lock 420, which are held in place vertically by the retainers 416 in the channel 414 portions of the respective lower retainer 326. Each lower retainer 326 is held against the dirt container 104 by the corresponding upper cover 328, which is screwed in place on the bracket 318 as described above and has protrusions 434 that press down on horizontal surfaces within holes 436 in the lower retainer 326 to clamp each lower retainer 326 to the respective bracket 318. These parts may be made from materials suitable to hold the required load and resist fatigue and damage from abrasion or other loads that are applied during installation and removal. Metals or strong plastics are examples of possible material choices. In alternative embodiments, the latches 110 may not be required to support the dirt container 104 against gravity. For example, the dirt container 104 may be installed on the housing 102 by rotating it along helical ramps, or on a bayonet-type fitting, that support the weight of the dirt container 104. As another example, the dirt container 104 may be attached to the side of the housing 102, as may be the case in some portable canister vacuum designs. In such cases, the parts may be constructed without regard to load-bearing capability.

In operation, the dirt container 104 may be detached from the upper housing 102 by pressing down on the buttons 320 on the latch assemblies 110, either simultaneously or successively. Each latch assembly 110 may be constructed such that it is strong enough to support the entire weight of the dirt container 104 on its own, which will help prevent accidents if a user only detaches one latch assembly 110, but this is not required. As noted above, depressing the button 320 compresses the spring 322, and the protrusions 426 on the button 320 press against the ramps 422 on the locking member 324 to generate a lateral vector force that disengages the lock 420 from the buckle 312. If desired, a lip or ramp may be added to the bottom of the lock 420 to prevent disengagement unless the user lifts or at least applies upward force to the bottom of the bracket 318. Once both latch assemblies 110 are released, the dirt container 104 may be lowered away from the upper housing 102. When pressure is released form the button 320, restoring force generated by the spring 322 returns the button 320 to the upper position, which moves the lock 420 back into the latching position. To reattach the dirt container 104, the user may simply raises it into place against the upper housing 102. Ramps 432 formed on the lock 420 engage the bottom of the buckle 312 as the dirt container 104 is being raised, and interaction between these parts drives the lock 420 away from the latching position until the dirt container 104 is raised to the point where the locks 420 snap into the slots 404 on the buckles 312. This automatic lock-defeating feature may be omitted in other embodiments, however, in which case it may be necessary for the user to depress the buttons 320 to reattach the dirt container 104. Once locked, the dirt container 104 is releasably attached to the upper housing 102 for operation of the central vacuum unit 100.

The foregoing exemplary arrangement provides several benefits and conveniences to the user. For example, the latches are conveniently formed as parts of handles, so that the user does not have to struggle to simultaneously hold and detach the dirt container. These handle/latches allow the user to lift on the dirt container as the latches are actuated, providing a one-step removal and attachment operation that can be easily performed by the typical user. As shown, the handles may comprise generally horizontal, planar upper and lower surfaces to assist with gripping, but they may be oriented at angles or vertically, may have loops into which the user can extend his fingers, and may be formed as knob-like projections or with other shapes. To provide the user with a firm grip on the dirt container, the handles may be rigid protrusions that do not move during operation of the latches, such as shown in the exemplary embodiment. In the shown arrangement, the user can firmly hold the bottom of each handle and depress each associated button without the handle moving relative to the dirt container.

The exemplary latches also may provide a firm fit between the parts that is strong enough to hold the dirt container in place even when full of dirt and maintain a suction seal between the dirt container and upper housing. The latches also may provide a positive lock that is easily engaged and not likely to be mistaken for being attached when it is not. This is particularly true if the locks are constructed to make an audible noise when they reengage the slots in the buckles. The latches also may be replaceable if they become worn or damaged, and may include an adjustment mechanism to raise and lower one or more of the latch parts to accommodate for any distortion in the shapes of the housings or deterioration in the seal that may occur over time due to cold flow of the material, manufacturing tolerances, physical damage, temperature changes, or other factors. Another benefit of exemplary embodiments is that the latches may be configured to automatically reengage simply by raising the dirt container into place. While these benefits are attained with the foregoing exemplary embodiment, it will be understood that they are not strictly required in all embodiments of the invention, and none of these benefits are intended to limit the claimed invention absent specific reference thereto in the claims.

It will also be understood that the foregoing exemplary embodiment may be modified in many ways without departing from the scope of the invention. For example, other arrangements of ramps, protrusions and other abutting structures may be provided between the button and the locking member to move the lock into and out of engagement with the buckle. Also, various parts may be omitted or formed integrally with other parts. For example, the buckle may simply comprise an extension of the upper housing. As another example, while the two latches in the shown embodiment are essentially identical, one of the latches may be replaced by a different connector. For example, one latch may be replaced by a simple hook and ledge/hole arrangement. In this embodiment, the hook is fitted to the ledge or hold, and the container is pivoted into position until the latch engages. Other examples of modifications may be to replace the sliding locking member with a rotating locking member, or to replace the vertically-operated button with a trigger that moves laterally. As another example, the rigid dirt container shown in the exemplary embodiment may be replaced by a bag or supplemented with multiple containment areas to hold dirt from plural dirt separators. The foregoing embodiments also may be modified as necessary to fit them into other vacuum cleaner applications, such as upright or canister vacuums. Other arrangements and variations will be readily apparent to persons of ordinary skill in the art in view of the present disclosure.

The embodiments described herein are all exemplary, and it will be appreciated that the embodiments shown herein can be used separately from one another, or in various combinations, and modified and adapted in various ways and for different uses. The description of the foregoing exemplary embodiments and variations thereof are not intended to limit the scope of the claimed invention in any way.

We claim:

1. A latch assembly for a central vacuum cleaner, the latch assembly comprising:
a buckle attached to a vacuum housing;
a lower latch assembly comprising:
a bracket connected to and extending laterally from a dirt container,
a locking member mounted on the bracket and having a lock thereon, the locking member being movable between a first lock position in which the lock engages the buckle to prevent removal of the dirt container from the housing, and a second lock position in which the lock does not engage the buckle to permit removal of the dirt container from the housing;
wherein at least a portion of the bracket is configured as a rigid handle adapted to be held by a user to remove and replace the dirt container.

2. The latch assembly of claim 1, wherein the buckle comprises a horizontal slot and the lock comprises a horizontal protrusion adapted to engage the horizontal slot when the locking member is in the first lock position.

3. The latch assembly of claim 1, wherein the locking member is slidably mounted on the bracket.

4. The latch assembly of claim 3, wherein the locking member is slidably mounted in a channel and retained in a vertical direction by one or more protrusions extending over the channel and the locking member.

5. The latch assembly of claim 1, wherein the locking member is contained within the bracket.

6. The latch assembly of claim 5, further comprising a button located on a surface of the bracket, the button being adapted to move from a first button position to a second button position to thereby move the locking member from the first lock position to the second lock position.

7. The latch assembly of claim 6, wherein the surface is the top surface of the bracket.

8. The latch assembly of claim 6, further comprising a spring adapted to move the locking member from the second lock position to the first lock position.

9. The latch assembly of claim 8, wherein the spring is adapted to move the locking member from the second lock position to the first lock position by moving the button from the second button position to the first button position.

10. The latch assembly of claim 1, wherein at least one of the lock and the buckle comprises a ramped surface adapted to displace the lock when the lower latch assembly is moved towards the buckle.

11. A latch assembly for a vacuum cleaner, the latch assembly comprising:
a buckle attached to a vacuum housing;
a lower latch assembly comprising:
a handle connected a dirt container;
a button mounted on the handle and adapted to move relative to the handle between a first button position and a second button position;
a spring adapted to bias the button from the second button position to the first button position;
a locking member adapted to move between a first lock position in which the locking member is positioned to engage the buckle, and a second lock position in which the locking member is positioned not to engage the buckle;
wherein the button has one or more first surfaces adapted to move the locking member from the first lock position to the second lock position when the button is moved from the first button position to the second button position, and one or more second surfaces adapted to move the locking member from the second lock position to the first lock position when the button is moved form the second button position to the first button position.

12. The latch assembly of claim 11, wherein the locking member is captured between the handle and the button.

13. The latch assembly of claim 11, wherein the handle extends generally horizontally from the dirt container.

14. The latch assembly of claim 11, wherein and the locking member is adapted to slide generally horizontally relative to the dirt container.

15. The latch assembly of claim 14, wherein the button is adapted to move generally vertically relative to the dirt container.

16. A central vacuum cleaner comprising:
an upper housing having a vacuum fan contained therein;
a dirt container adapted to selectively connect to a bottom of the upper housing to receive dirt separated by the central vacuum cleaner from an air flow generated by the vacuum fan;
at least one buckle extending downward from the upper housing;
at least one latch mounted on the dirt container to selectively connect the dirt container to the upper housing, the at least one latch comprising:
a handle rigidly attached to the dirt container and configured to be held by a hand of a user;
a movable button located on the dirt container at a location where the button can be operated by the hand of the user while the hand is holding the handle; and
a lock movable by the button between a first position in which the lock is positioned to engage the buckle, and second position in which the lock is positioned not to engage the buckle.

17. The central vacuum cleaner of claim 16, wherein the handle extends laterally from a side of the dirt container.

18. The central vacuum cleaner of claim 17, wherein the button is mounted on a top surface of the handle.

19. The central vacuum cleaner of claim 16, wherein the at least one latch is adapted to automatically move from the first position to the second position when the dirt container is moved into contact with the upper housing for installation.

20. The central vacuum cleaner of claim 16, wherein the at least one latch comprises two latches mounted on generally opposite sides of the dirt container.
